(19) United States
(12) Patent Application Publication
(10) Pub. No.: US 2016/0207240 A1
(43) Pub. Date: Jul. 21, 2016

(54) INJECTION MOLDED NOZZLE PREFORM WITH UNDERCUT MICRO FEATURES

(71) Applicant: 3M INNOVATIVE PROPERTIES COMPANY, Saint Paul, MN (US)

(72) Inventors: Ramasubramani Kuduva Raman Thanumoorthy, Woodbury, MN (US); Barry S. Carpenter, Oakdale, MN (US); Paul A. Martinson, Maplewood, MN (US); David H. Redinger, Afton, MN (US); Joseph S. Warner, Hammond, WI (US)

(21) Appl. No.: 14/914,162

(22) PCT Filed: Aug. 29, 2014
(86) PCT No.: PCT/US2014/053467

§ 371 Date: Feb. 24, 2016

Related U.S. Application Data
(60) Provisional application No. 61/874,764, filed on Sep. 6, 2013.

(51) Int. Cl. B29C 45/44

(52) U.S. Cl. CPC B29C 45/4407; B29K 2023/12

(57) ABSTRACT

Injection Molded Nozzle Preform with Undercut Features Injection molded nozzle preforms (100) are disclosed. More specifically, an injection molded nozzle preform (100) with undercut features (120A, 120B,120C) is disclosed. The undercut features (120A, 120B,120C) extend from a major surface of a substrate (110), and have at least two non-parallel axis. An injection molded nozzle preform made from polypropylene is also disclosed.

### BACKGROUND

Nozzle preforms are useful as an intermediate step in manufacturing nozzles. Generally, the nozzle preform is electroformed to create what may be the final nozzle plate, array, or part. In many precision applications, the particular arrangement, shape, and size of the features on the nozzle plate may be of high importance, including the ability to design and produce arrays with features independently and accurately aimed. Injection molding is commonly used to produce parts at high throughput owing to its ability to be repeatable and automatable without the need for frequent retooling. Incorporating undercut features into an injection molded article has previously required complicated mold design, such as removable pins, or accepted permanent deformation of features in removing the article from the mold. Using removable pins is inappropriate or unworkable at some size scales and for some shapes of features and permanent deformation is unacceptable for precision applications.

### SUMMARY

In one aspect, the present disclosure relates to nozzle preform. More specifically, the present disclosure relates to nozzle preform including a substrate including a first major surface and a plurality of single-axis microfeatures extending from the first major surface of the substrate, where each single-axis microfeature has a principal axis. The principal axes of the plurality of single-axis microfeatures are non-parallel. The injection molded nozzle preform has no broken or deformed microfeatures. In some embodiments, each of the plurality of single-axis microfeatures has a surface interface area and a plan view projection area, the plan view projection width extending beyond the surface interface area for at least a portion of the plurality of single-axis microfeatures. In some embodiments, the plurality of single-axis microfeatures includes polypropylene, which may have a melt flow index of 1.2. In some embodiments, the plurality of single-axis microfeatures are cylindrical. In some embodiments, the plurality of single-axis microfeatures taper away from the substrate. In other embodiments, the plurality of single-axis microfeatures do not taper away from the substrate. In some embodiments, non-parallel means at least two of the principal axes deviate from one another by at least 10, 20, 30, or 40 degrees. In some embodiments, non-parallel means at least two of the principal axes deviate from one another by between 10 and 40 degrees.

### BRIEF DESCRIPTION OF THE DRAWINGS

FIG. 1 is a sectional elevation view of an injection molded nozzle preform.

FIG. 2 is a sectional elevation view of a mold.

FIG. 3 is a sectional elevation view of a nozzle preform being injection molded in the mold of FIG. 2.

FIG. 4 is a sectional elevation view of another injection molded nozzle preform.

FIG. 5 is a top perspective view of another injection molded nozzle preform.

FIG. 6 is a top perspective schematic of a mold used in Example 1 and the comparative examples.

FIG. 7a is a side cross-sectional schematic of the hole configuration of the mold of FIG. 6.

FIG. 7b is a top plan schematic of the hole configuration of the mold of FIG. 6.

FIG. 8 is a composite micrograph of the injection molded nozzle preform of Example 1.

FIG. 9 is a micrograph of the injection molded nozzle preform of Comparative Example 1.

FIG. 10 is a micrograph of the injection molded nozzle preform of Comparative Example 5.

FIG. 11 is a micrograph of the injection molded nozzle preform of Comparative Example 6.

### DETAILED DESCRIPTION

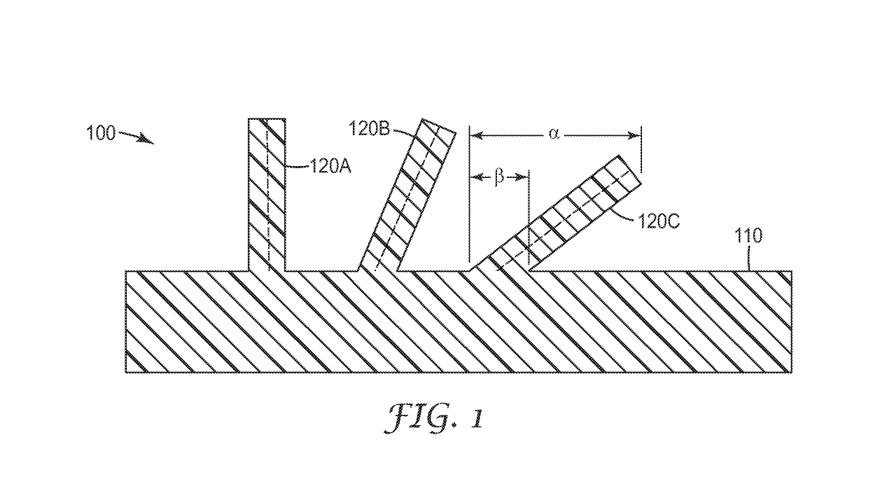

It should be understood that the term “nozzle” may have a number of different meanings in the art. In some specific references, the term nozzle has a broad definition. For example, U.S. Patent Publication No. 2009/0308953 A1 (Palestrant et al.) discloses an “atomizing nozzle” which includes a number of elements, including an occlude chamber 50. This differs from the understanding and definition of nozzle put forth herein. For example, the nozzle of the current description would correspond generally to the orifice insert 24 of Palestrant et al. In general, the nozzle of the current description can be understood as the final tapered portion of an atomizing spray system from which the spray is ultimately emitted; see, e.g., Merriam Webster's dictionary definition of nozzle (“a short tube with a taper or constriction used (as on a hose) to speed up or direct the flow of fluid.”) Further understanding may be gained by reference to U.S. Pat. No. 5,716,009 (Ogihara et al.). In this reference, again, fluid injection “nozzle” is defined broadly as the multi-piece valve element 10; see col. 4, lines 26-27 (“fuel injection valve 10 acting as fluid injection nozzle . . . ”). The current definition and understanding of the term “nozzle” as used herein would relate to first and second orifice plates 130 and 132 and potentially sleeve 138 (see FIGS. 14 and 15 of Ogihara et al.), for example, which are located immediately proximate the fuel spray. A similar understanding of the term “nozzle” to that described herein is used in U.S. Pat. No. 5,127,156 (Yokoyama et al.). There, the nozzle 10 is defined separately from elements of the attached and integrated structure, such as swirler 12 (see FIG. 1(II)). The above defined understanding should be kept in mind when the term “nozzle” is referred to throughout the remainder of the description and claims. Nozzle may also refer to a nozzle plate or array; i.e., a collection of through-holes on a single part. Similarly, a set of nozzles, nozzle arrays, or nozzle plates that are manufactured together and later cut or otherwise separated may also qualify under this definition of nozzle.

FIG. 1 is a sectional elevation view of an injection molded nozzle preform including undercut features. Injection molded nozzle preform 100 includes base 110 and features 120A, 120B, and 120C. Base 110 may be any suitable material. In some embodiments, base 110 is the same material as the features; for example, the features may be formed from injecting the same material in the same mold. Base 110 may have any suitable cross-sectional shape and any suitable overall three-dimensional characteristics and is not restricted to the substantially planar shape suggested by its illustration in FIG. 1. In some embodiments, base 110 may be in the shape of a disc or wafer.

Base 110 may have any suitable thickness and may be designed to have sufficiently substantial dimensions to be warp resistant or to provide stability for subsequent processing steps for nozzle preform 100. Base 110 may also be specifically shaped to properly interface with other parts or components in the nozzle system. In some embodiments, base 110 of nozzle preform 100 may be designed to have a desired size or shape after subsequent electroforming steps; in other words, base 110 may be slightly smaller than the desired final nozzle part.

120A, 120B, and 120C (collectively, features 120) extend from a major surface of base 110 and may be any desirable shape or size. In some embodiments, features 120 may be microfeatures; i.e., they may have dimensions on the order of microns or tens or hundreds of microns. In some embodiments, features 120 may be substantially cylindrically shaped. The shape and profile of features 120 may be carefully selected to ultimately provide, out of the finished part, a desired fluid flow profile and precise control of the output stream including its coherence, directionality, velocity and diameter. In some embodiments, features 120 may have a draft angle, meaning they taper away from base 110.

Each of features 120A, 120B, and 120C has a principal axis that generally follows the contour of the feature. In FIG. 1 these axes are illustrated with dashed lines. Nozzle preform 100 includes features 120 having linear axes; however, as long as features 120 are single-axis features, the axes may be linear or curved. Single-axis features means that the features have a principal axis that may be defined by only a single line or a single curve, and that the axis does not double back on itself or abruptly change directions. As can be seen in FIG. 1, the principal axes of feature 120A, feature 120B, and 120C are non-parallel. Tapering or having a slight draft angle does not affect the definition or identification of the principal axes. For curved principal axes where a determination of whether two axes are parallel or not may be more difficult, axes may be considered non-parallel if they have either a different shape or a different alignment (e.g., one curved axis may be non-parallel to a second if the second is a rotation of the first around a normal axis to a major surface of base 110).

Features 120B and 120C may be characterized as undercut features. As an example, feature 120C is labeled to indicate its extension width, or plan view projection width, α, and its base width, or surface interface width, β. Feature 120C may be considered undercut because α extends beyond β. It should be understood that the values of α and β may vary based on the sectional elevation view chosen, but the features may still be considered undercut as long as there is at least one sectional elevation view for which α>β is true.

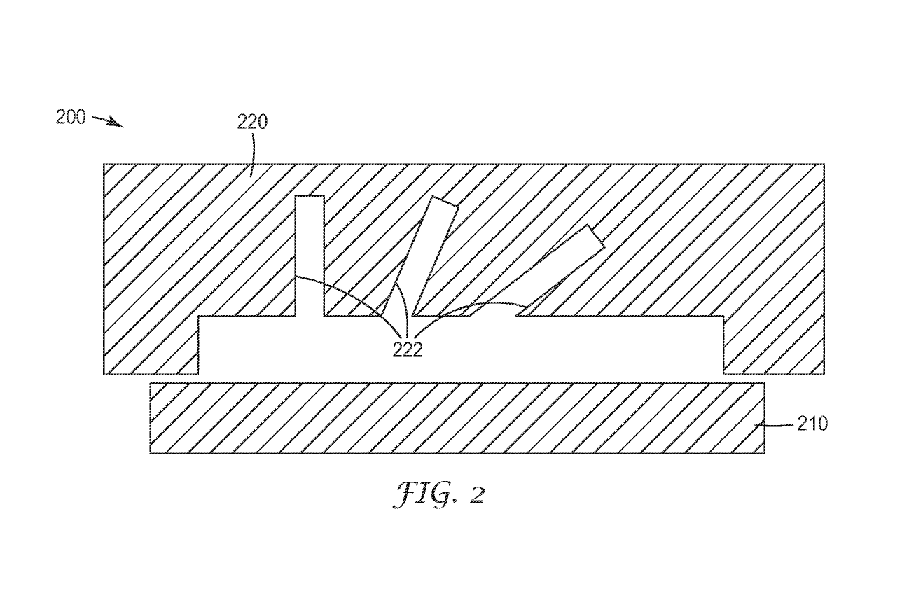

Any number of features 120 is possible, depending on the desired application. While FIG. 1 depicts features 120 all being of the same general shape and size, this is not necessary. Any combination or arrangement of shapes for features 120 are possible and may be considered within the scope of this disclosure. FIG. 2 is a sectional elevation view of a mold. Mold 200 may be designed to help form the nozzle preform 100 of FIG. 1 through injection molding. Mold 200 is depicted as being in two parts, bottom plate 210 and top plate 220. Top plate 220 includes feature grooves 222.

Molds for injection molding are often in two or more parts to facilitate the removal of the molded part. Referring to mold 200 depicted in FIG. 2, bottom plate 210 and top plate 220 may simply be held together with pressure (i.e., may have no special features joining the two), or they may have protrusions or recessions that interlock. In some embodiments, one of bottom plate 210 and top plate 220 may be stationary or fixed while the other is repositionable or removable. In some embodiments bottom plate 210 may fit inside or nestle within top plate 220.

Mold 200 may be formed from any suitable material. In some embodiments, the material of bottom plate 210 and top plate 220 may be the same. In some embodiments, suitable materials may be metallic, ceramic, or polymeric, and may be selected based on heat conductance, resistance to deformation or warping, durability, and anti-stick properties. In some embodiments, bottom plate 210 or top plate 220 may be a metal alloy, such as steel. Note that a coated or surface treated mold 200 may be unacceptable for many applications because of the risk of contaminants affecting the subsequent electroforming steps or being present undesirably in a finished part. Channels 222 (corresponding to the negative of features 120 of FIG. 1) may be provided in top plate 220 through any suitable process, including laser drilling, electrical discharge machining, or electroforming a negative (such as nozzle preform 100 of FIG. 1), where the negative is generated by any suitable method, such as casting and curing, or a multiphoton process such as that described in, for example, U.S. Patent Application Publication No. 2009/0099537, entitled “Process For Making Microneedles, Microneedle Arrays, Masters, And Replication Tools,” filed Mar. 23, 2007.

Channels 222 correspond to features 120 of FIG. 1. Depending on the application, it may be important that channels 222 maintain high fidelity to the desired ultimate shape of the finished part. Channels 222 may be designed to account for thermal expansion or contraction after an injection molded part is decoupled from mold 200.

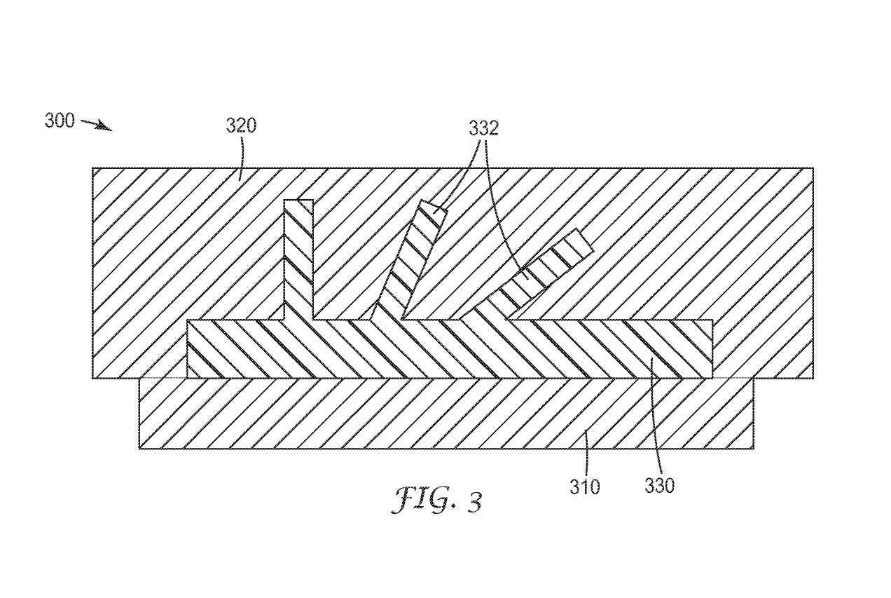

FIG. 3 is a side elevation view generally showing the step of injection molding. Mold 300 includes bottom plate 310, top plate 320, and injected material 330 including undercut features 332. It should be understood by one skilled in the art that FIG. 3 depicts only a generalized view of the injection molding step, and an injection molding system would likely include other components, such as sidewalls, injection gates, appropriate input lines, and heating elements to achieve the appropriate material properties from injected material 330.

Material selection of injected material 330 is important to ensure the clean ejection, decoupling, or removal of the finished part, and especially undercut features 332, from mold 300. Because the removal of the finished part from mold 300 uses a straight pull, e.g., in the system illustrated in FIG. 3, downward (toward the bottom of the page), undercut features 332 experience forces not along their principal axes, which tend to break or severely deform the features. The breaking of undercut features 332 is a particular problem because not only is the injection molded part rendered defective, but the broken portion often remains in or clogs the holes in the injection mold, making it much more likely that further parts will be defective without cleaning, melting or dissolving away, or otherwise removing the broken portion from the mold. This tendency to break is generally a function, among other things, of the undercut feature's principal axis's deviation from normal (or, in a more generalized case, the deviation from the line including the vector along which the injection molded part is removed) and of the shape and dimensions of the undercut feature. Notably the tendency to break is particularly related to the material or combination of materials selected as injected material 330.

The parameters of the injection molding process may be selected according to the desired application. For example, mold 300 is commonly heated in order to enable injected material 330 to flow into the features of the mold (for example, channels 222 depicted in FIG. 2). In some embodiments it may be desirable to set a temperature as close to room temperature as possible for mold 300.

In applications where precise design and high fidelity replication is desired, it may be unacceptable to break any of features 332 during the injection molding process. Similarly, it may be unsuitable to have any significant surface defects or deformation, or, at least, any unpredictable or highly variable deformation that is not able to be controlled through design of mold 300.

FIG. 4 is a sectional elevation view of another injection molded nozzle preform. As in FIG. 1, nozzle preform 400 includes base 410 and features 420A and 420B. FIG. 4 illustrates some of the possible variations in the design of the injection molded features. Feature 420B is undercut (α, the plan view projection width is greater than the surface interface width, β) and features 420A and 420B are non-parallel. Compared with nozzle preform 100 of FIG. 1, however, features 420A and 420B of FIG. 4 incorporate a significant draft angle. The sectional elevation view depicted in FIG. 4, though helpful in illustrating certain features, should not be interpreted as limiting the arrangement of the features on nozzle preform 400. For example, the features could be arranged in a Cartesian array, in concentric circles, or in some combination of the both. In some embodiments the features may be symmetric across one or more planes, and in some embodiments the features may be arranged randomly or pseudorandomly (although, given the nature of injection molding, each injection molded nozzle preform formed from the same mold will be identical to or resemble the others). In some applications, each feature may be designed to spray or direct fluid in a unique direction.

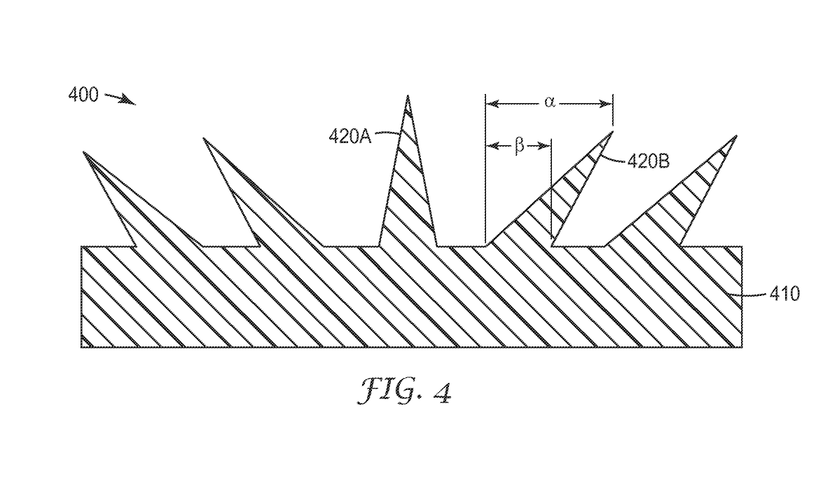

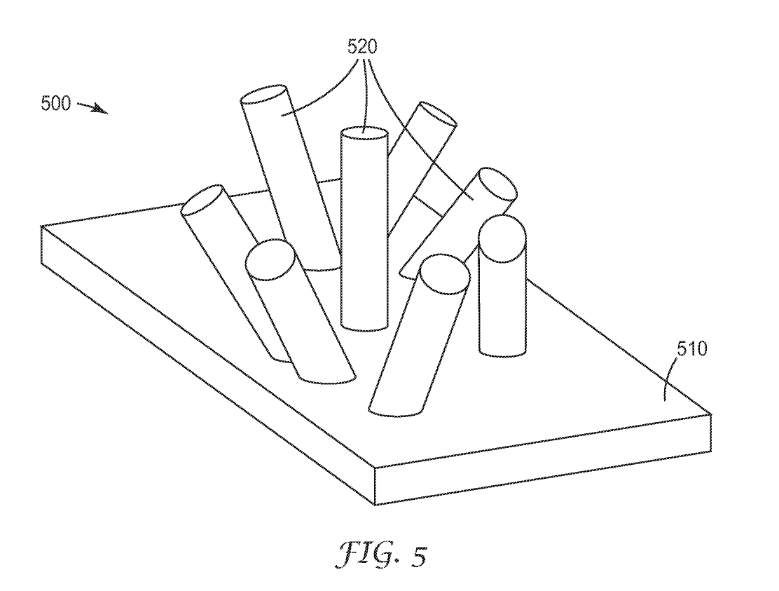

FIG. 5 is a top perspective view of another injection molded nozzle preform. Nozzle preform 500 includes base 510 and features 520. FIG. 5 shows a configuration including features aimed in many different directions. Nozzle preform 500 includes features 520 have different orientations and have different lengths and widths. Although not explicitly labeled, the plan view projection width for most of features 520 are greater than the surface interface width, making features 520 undercut. With arrangements of features possible like those shown in FIG. 5, one skilled in the art will recognize the opportunities to precisely control the direction, velocity, and volumetric flux of fluid ejected through the nozzle or the overall shape of an atomized spray.

### EXAMPLES

### General Method for Injection Molding Nozzle Preforms

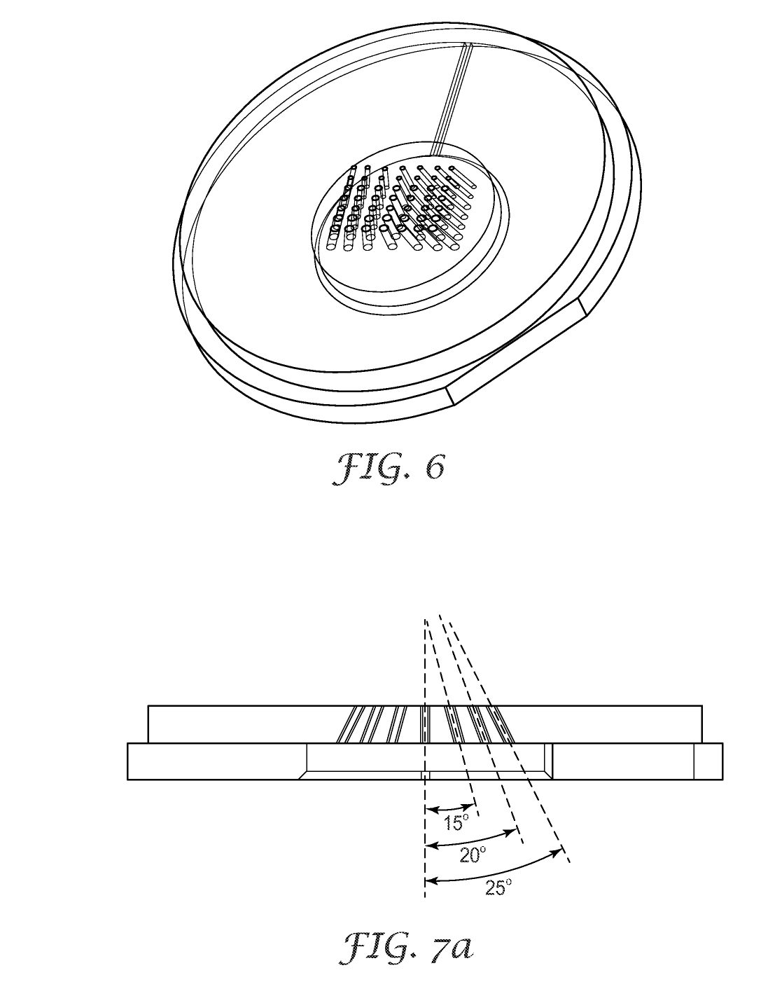

A general purpose thermal cycling mold with oil and water channels to maintain the desired injection molding temperature was used. The mold base comprised of two halves: a stationary side (A-side) and a moving side (B-side). An outer insert made out of high thermal conductive Cu alloy housed an internal insert that contained the microfeatures. The internal insert containing the microfeatures is shown in the FIG. 6. The microfeatured internal insert was made using machining and the through holes were created using wire-EDM.

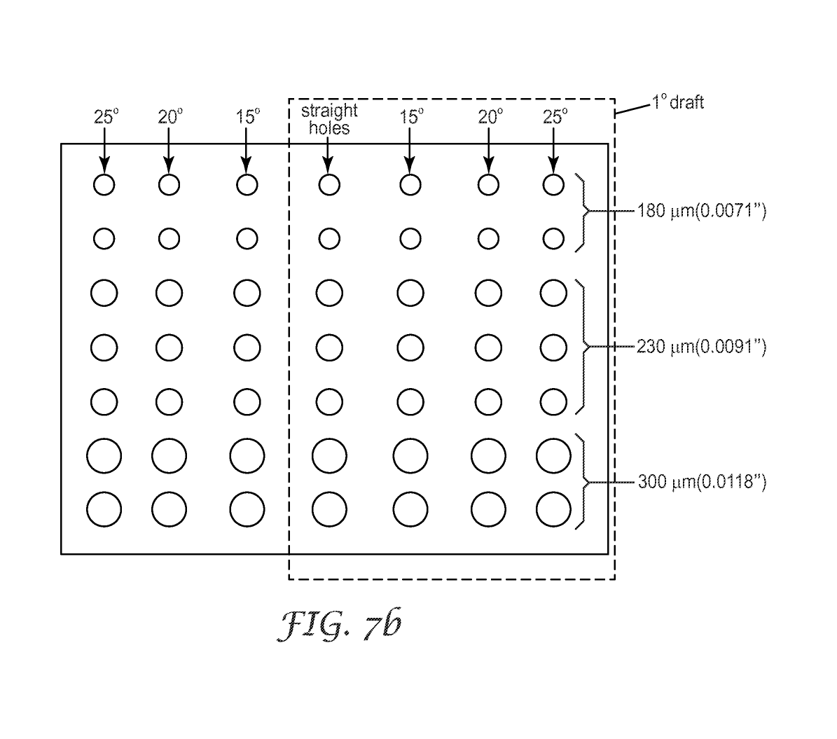

The internal insert containing the microfeatures contained a seven-by-seven array of holes including two rows each of 180 and 300 μm diameter holes and three rows of 230 μm diameter holes. The seven columns of holes included a column with straight (normal to the surface) incidence, and two each at 15°, 20°, and 25° deviation from normal. One column of each angle (straight, 15°, 20°, and 25°) were created with a 1° draft angle while the other column of each angle were created without a draft angle. The holes were between 1 and 1.3 mm deep. Forty-nine holes in total were created, with half a millimeter between the centers of the holes. The insert design also included a vent pin, a vent pocket and square, 250 μm ( 1/100^{th} or 0.01 inch) by 250 μm ( 1/100^{th} or 0.01 inch) vent channels. Schematic diagrams of cross-sectional and top perspective of the insert are shown in FIGS. 7a and 7b, respectively.

The plan view projection width, α, and its base width, or surface interface width, β for some of the microfeatures of the internal insert are given in Table 1, below.

TABLE 1

Microfeature

| Diameter | Angle from normal | | |
|---|---|---|---|
| (μm) | (degrees) | α | β |
| 310 | 15 | 589 | 358 |
| 310 | 20 | 718 | 358 |
| 310 | 25 | 868 | 358 |
| 180 | 15 | 474 | 189 |
| 180 | 20 | 550 | 189 |
| 180 | 25 | 628 | 189 |

A variety of polymers and homopolymers were then injection molded using the above described mold using well known injection molding techniques and parameters. The injection pressure was about 55.16 MPa (8000 psi), at an injection speed of 7.5 cm/s (3 in/s) and a fill time of 0.12 s. The holding pressure was 27.58 MPa (4000 psi) and holding time was 4 s. The mold temperature was varied from about 15.6° C. to 82.2° C. (60° F. to 180° F.). Once the molding was completed the mold parts were opened (at a speed of 7.62 mm/s) and the molded nozzle preform parts were ejected (at a speed of 12.7 mm/s) using pin ejectors with a diameter of 2.34 mm. The prepared nozzle preform morphology was observed using microscopy.

### Example 1

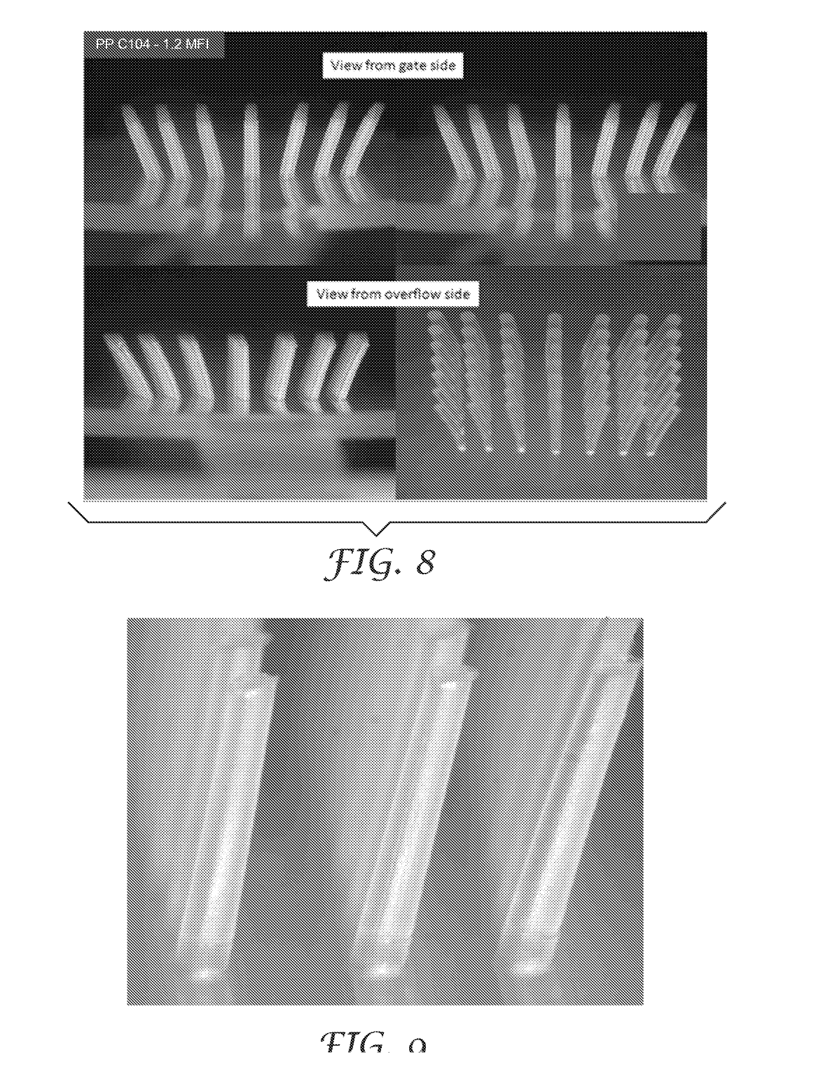

An impact copolymer of polypropylene (PP) having a MFI of 1.2 (obtained from Dow Chemicals, Midland, Mich. under trade designation “C104-1”) was used as an injection molding material and a nozzle preform was prepared using the “General method for injection molding nozzle preforms” described above. The mold insert was maintained at 46.1° C. (115° F.) for the injection molding step. The resulting nozzle preform was observed using microscopy The microfeatures ejected smoothly, remained intact and showed no obvious deformation. A composite micrograph of the Example 1 nozzle preform is shown in FIG. 8.

### Comparative Example 1

Comparative Example 1 was run in the same manner as Example 1 except that the mold insert was maintained at 82° C. (180° F.). The resulting nozzle preform was observed using microscopy to indicate minor damage incurred at the base of some microfeatures A micrograph of the Comparative Example 1 nozzle preform is shown in FIG. 9.

### Comparative Example 2

Comparative Example 2 was run in the same manner as Example 1 except that the mold insert was maintained at 37.8° C. (100° F.). The resulting nozzle preform was observed using microscopy to indicate minor damage incurred at the base of some microfeatures similar to those of Comparative Example 1.

### Comparative Example 3

Comparative Example 3 was run in the same manner as Comparative Example 1 except that the injection molding material was a PP material having a MFI of 13 (obtained from Exxon Mobil Chemical, Houston, Tex. under the trade designation “Exxon Mobil PP1024E4”). The resulting nozzle preform was observed using microscopy to indicate minor damage incurred at the base of some microfeatures similar to those of Comparative Example 1.

### Comparative Example 4

Comparative Example 4 was run in the same manner as Comparative Example 1 except that the injection molding material was a PP material having a MFI of 38 (obtained from Total Petrochemicals, Houston, Tex. under the trade designation “Polypropylene 3868”). The resulting nozzle preform was observed using microscopy to indicate minor damage incurred at the base of some microfeatures similar to those of Comparative Example 1.

### Comparative Example 5

Comparative Example 5 was run in the same manner as Example 1 except that the injection molding material was a Nylon 66 material (obtained from DuPont Performance

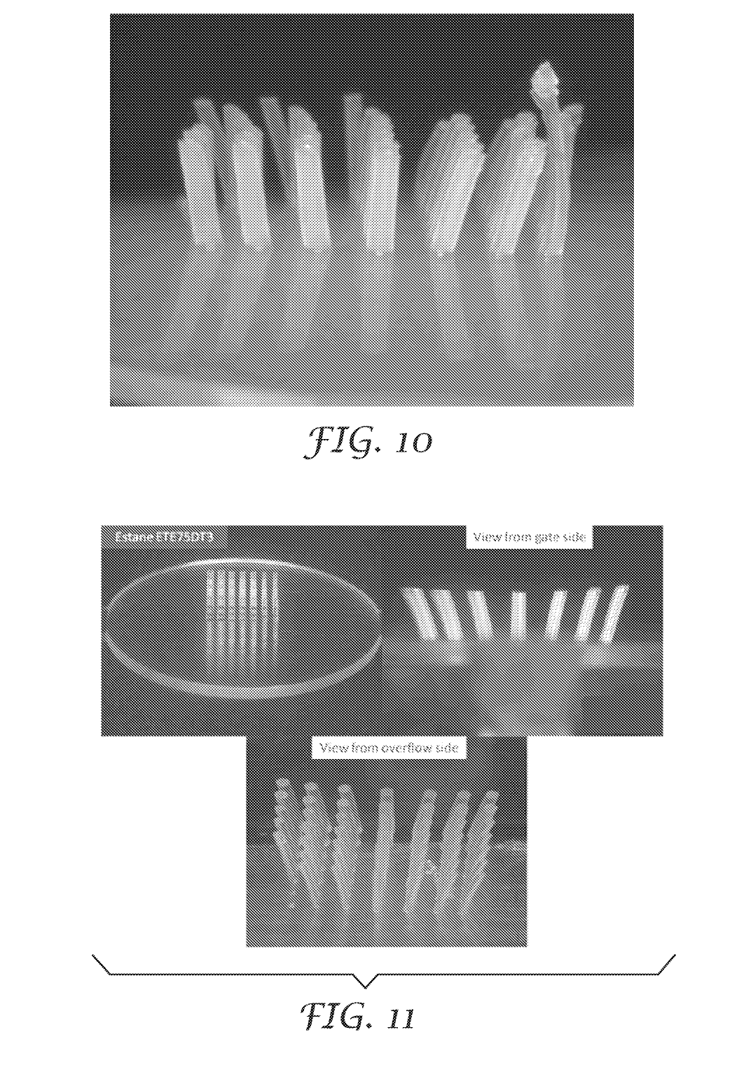

Polymers, Wilmington, Del. under the trade designation “Zytel 101L N C1010”) and the mold insert was maintained at 96.1° C. (205° F.). The resulting nozzle preform was observed using microscopy to indicate some microfeatures having plastic deformation caused during ejection. A composite micrograph of the Comparative Example 5 nozzle preform is shown in FIG. 10.

### Comparative Example 6

Comparative Example 6 was run in the same manner as Example 1 except that ESTANE ETE75DT3, (a thermoplastic polyurethane, 75D shore hardness, available from Lubrizol, Wickliffe, Ohio) was used as the injection molding material. The mold temperature was maintained at 46.1° C. (115° F.) for the injection molding step. The resulting nozzle preform was observed using microscopy. A composite micrograph of the Comparative Example 6 preform showing two missing 180 μm features is shown in FIG. 11. While not wishing to be bound by theory, the damage (broken off microfeatures) is believed to be caused during ejection.

### Comparative Example 7

Comparative Example 7 was run in the same manner as Comparative Example 6 except that ESTANE 58134 (a thermoplastic polyurethane, 45D shore hardness, available from Lubrizol, Wickliffe, Ohio) was used as the injection molding material. When viewed by microscopy, the resulting Comparative Example 7 nozzle preform showed microfeatures with showed extensive damage similar to those seen in Comparative Example 6 (i.e., several missing microfeatures).

1. An injection molded nozzle preform comprising:
a substrate having a first major surface and a plurality of single-axis microfeatures extending from the first major surface of the substrate, each single-axis microfeature having a principal axis, wherein the principal axes of the plurality of single-axis microfeatures are non-parallel, and the injection molded nozzle preform has no broken or deformed microfeatures.

2. The preform of claim 1, wherein each of the plurality of single-axis microfeatures has a surface interface area and a plan view projection area, the plan view projection width extending beyond the surface interface area for at least a portion of the plurality of single-axis microfeatures.

3. The preform of claim 1, wherein the plurality of single-axis microfeatures comprises polypropylene.

4. The preform of claim 1, wherein the plurality of single-axis microfeatures are cylindrical.

5. The preform of claim 1, wherein the plurality of single-axis microfeatures taper away from the substrate.

6. The preform of claim 1, wherein the plurality of single-axis microfeatures do not taper away from the substrate.

7. The preform of claim 3, wherein the polypropylene has a melt flow index of about 1.2.

8. The preform of claim 1, wherein non-parallel means at least two of the principal axes deviate from one another by at least 10 degrees.

9. The preform of claim 1, wherein non-parallel means at least two of the principal axes deviate from one another by at least 20 degrees.

10. The preform of claim 1, wherein non-parallel means at least two of the principal axes deviate from one another by at least 30 degrees.

11. The preform of claim 1, wherein non-parallel means at least two of the principal axes deviate from one another by at least 40 degrees.

12. The preform of claim 1, wherein non-parallel means at least two of the principal axes deviate from one another by between 10 and 40 degrees.

13. The preform of claim 12, wherein the plurality of single-axis microfeatures are cylindrical or taper away from the substrate.

14. A nozzle made using the preform of claim 1, said nozzle comprising a plurality of through-holes corresponding to the plurality of single-axis microfeatures.

15. The nozzle of claim 14 being a fuel injection nozzle.

16. A fuel injector comprising the nozzle of claim 15.

17. A method of making a nozzle using the nozzle preform of claim 1, said method comprising:
electroforming the nozzle preform to create a nozzle plate, array, or part having a plurality of through-holes corresponding to the plurality of single-axis microfeatures; and
removing the nozzle preform from the nozzle plate, array, or part.

18. A method of making a nozzle, said method comprising:
providing a mold comprising a plurality of groove features;
injection molding a nozzle preform using the mold, with the nozzle preform comprising a substrate having a first major surface and a plurality of single-axis microfeatures extending from the first major surface of the substrate, each single-axis microfeature having a principal axis and being the negative of a groove feature of the mold, wherein the principal axes of the plurality of single-axis microfeatures are non-parallel;
removing the injection molded nozzle preform from the mold without any broken or deformed microfeatures;
electroforming the nozzle preform to create a nozzle plate, array, or part having a plurality of through-holes corresponding to the plurality of single-axis microfeatures; and
removing the nozzle preform from the nozzle plate, array, or part.

19. The method of claim 18, wherein non-parallel means at least two of the principal axes deviate from one another by between 10 and 40 degrees.

20. The method of claim 19, wherein the plurality of single-axis microfeatures are cylindrical or taper away from the substrate.
